(19) United States
(12) Patent Application Publication
(10) Pub. No.: US 2015/0269658 A1
(43) Pub. Date: Sep. 24, 2015

(54) AUDIO-ONLY FILE PROVISIONING FROM INTERNET VIDEO

(71) Applicant: Edward C. DeFeudis, Darien, CT (US)

(72) Inventors: Edward C. DeFeudis, Darien, CT (US); Lanka Ravindra Krishna Kumar, Hyderabad (IN)

(73) Assignee: Edward C. DeFeudis, Darien, CT (US)

(21) Appl. No.: 14/219,448

(22) Filed: Mar. 19, 2014

(51) Int. Cl. G06Q 30/06; G11B 27/034

(52) U.S. Cl. CPC G06Q 30/0641; G06Q 30/0621; G11B 27/034

(57) ABSTRACT

An artist can append a special purchase link to an audio video (AV) file that can be selected by a user to purchase only the audio portion of the AV, which, if not already stored on the server hosting the service, is extracted from the AV, sent to the user, and stored on the host server for retrieval pursuant to subsequent requests from users to purchase only the audio.

### I. FIELD OF THE INVENTION

The application relates generally to audio-only file provisioning from Internet videos.

### II. BACKGROUND OF THE INVENTION

Audio tracks stored as digital files increasingly are incorporated into audio-video (AV) objects, e.g., such as may be provided on Internet sites. As understood herein, for both business and personal reasons, both audio artists and audio consumers may want to purchase only audio portions of AV streams without necessarily paying for and/or downloading the video portion.

### SUMMARY OF THE INVENTION

As further understood herein, to play a video on a web page, Internet browsers typically use flash player (“Player”) or some equivalent plugin. When a user visits a video web page such as may be available on YouTube, or a page where a video play script is embedded, the browser invokes a plugin such as flash player. To enable the flash player to know what stream to download from the site, video web pages allow players to call an application programming interface (API) that enables the player to obtain video identification, which essentially is encrypted data that contains a network address such as a uniform resource locator (URL) at which the video stream can be accessed by the player.

According to present principles, an audio artist such as a musician whose audio is part of an AV stream such as a music video can upload the AV file to an AV page hosted by a web server. The artist may access a service account website to establish an account, and after the artist establishes an account, the artist may cause to have a link, sometimes referred to herein as a one-click consumer purchase link (“CPL”) added to one or all of the artist's AV files that are accessible on the AV page. The CPL in some embodiments may be electronically located in the description area of the AV page.

Subsequently, consumers, when visiting the AV web pages, may click on the CPL of an AV file, which redirects the consumer computer to an audio purchase shopping cart web page. As part of the redirection, the AV page address, consumer computer address, and the identification of the selected AV file is provided to the shopping cart web page. Using the shopping cart web page, a consumer can pay for the audio portion of the AV file. Responsive to successful payment, an audio purchase service, typically hosted and/or executed by a web-based server associated with the shopping cart web page (which, recall, is provided with the network address of the AV page, the consumer computer address, and the identification of the selected AV file) accesses the AV page to in turn access the selected AV file. The service then fetches the selected AV file from the AV page.

The service then extracts the audio portion of the selected AV file using a system tool such as “FFmpeg” to extract the audio file (typically but not necessarily formatted as MP3) from the AV file, downloading and storing the audio-only file on its server storage. “Extract” connotes “copy” in that after extraction, the audio file remains part of the selected AV file on the AV page or site as well as now residing on the server storage of the service. Using the consumer computer address received as divulged above, the service downloads the audio-only file to the consumer computer. Preferably, the audio file is sent to the data partition identified by the consumer computer as the consumer's media library.

Thus, as consumers purchase the audio-only portions of AV files, each audio-only portion is stored by the service on its server. Furthermore, as part of storing the audio-only files, the service labels each audio file with a unique identifier, which in some embodiments may include the address of the AV page hosting the combined AV file, a unique subscript, and the identification of the combined AV file itself. Therefore, for subsequent audio file-only purchases, the service can first search its own server storage by the identification of the combined AV file associated with the desired audio file and if found on its own server, downloads the audio file to the subsequent purchasing consumer. The service thus need access combined AV files and extract audio therefrom only for the initial purchase of any particular audio file, e.g., only for the initial purchase of a song, otherwise directly accessing the audio file (e.g., song) on its own storage.

Accordingly, a device includes at least one computer readable storage medium bearing instructions executable by a processor, and at least one processor configured for accessing the computer readable storage medium to execute the instructions to configure the processor to, responsive to a selection from a user computer of a link on an audio video (AV) web page indicating a desire to purchase only an audio portion of an AV object, provide a purchase web page to the user computer. The instructions when executed by the processor configure the processor to, responsive to a successful purchase of the audio portion, determine whether the audio portion is stored in a device storage at least in part using an identification of the audio portion, and responsive to a determination that the audio portion is stored in the device storage, to download a copy of the audio portion from the device storage to the user computer. Responsive to a determination that the audio portion is not stored in the device storage, the processor when executing the instructions is configured to access the AV object, extract a copy of the audio portion therefrom to establish an extracted copy, and provide the extracted copy to the user computer, and further to store the extracted copy on the device storage.

In some examples, the identification of the audio portion is established at least in part by the address of the AV web page and an identification of the AV object. The identification of the audio portion may be further established at least in part by a subscript.

In non-limiting implementations, the instructions when executed by the processor further configure the processor to, responsive to a determination that the audio portion is not stored in the device storage and establishing the extracted copy, add the identification of the audio portion to the extracted copy. In some embodiments, the AV object includes a video-only file and an audio-only file, and the AV object can be a music video and the audio-only file can be a music file.

In another aspect, a method includes, responsive to a purchase request from a user computer, accessing a data storage storing an audio video (AV) entity containing digitized video and audio that is associated with the video. Only the audio is extracted from the AV entity. The method includes providing, pursuant to the purchase request, only the audio to the user computer and not providing video from the AV entity to the user computer pursuant to the purchase request.

In another aspect, a device includes at least one computer readable storage medium bearing instructions executable by a processor and at least one processor configured for accessing the computer readable storage medium to execute the instructions to configure the processor to establish an audio purchase account with an audio purchasing service (APS) for at least a first artist having at least an artist computer and a system identification with at least one audio video (AV) Internet site on which the first artist has provided one or more AV objects having respective audio portions. Using the system identification in the audio purchase account, the processor executing the instructions is configured to fetch from the AV Internet site indicators of the AV objects associated with the first artist to generate a list of the AV objects. The processor when executing the instructions is configured to provide a user interface (UT) to the artist computer including the list of the AV objects and one or more selectors enabling the artist to select to append, on the AV Internet site, audio-only purchase links to one or more of the AV objects. Responsive to selection of one or more selectors, the processor when executing the instructions is configured to append to one or more pages on the AV Internet site of selected AV objects from the UI respective audio-only purchase links. Each audio-only purchase link is selectable by a consumer accessing the AV Internet site to link the consumer to the APS to facilitate a transaction for the audio but not the video associated with the audio-only purchase link selected by the consumer.

In another aspect, a device includes at least one computer readable storage medium bearing instructions executable by a processor, and at least one processor configured for accessing the computer readable storage medium to execute the instructions to configure the processor to establish an audio purchase account with an audio purchasing service (APS) for at least a first artist having at least an artist computer and a system identification with at least one audio video (AV) Internet site on which the first artist has provided one or more AV objects having respective audio portions. The instructions when executed by the processor configure the processor to, using the system identification in the audio purchase account, fetch from the AV Internet site indicators of the AV objects associated with the first artist to generate a list of the AV objects, and to provide a user interface (UI) to the artist computer including the list of the AV objects and one or more selectors enabling the artist to select at least a first AV object. The instructions when executed by the processor configure the processor to, responsive to artist selection of the first AV object, obtain from the AV Internet site at least a sample of audio associated with the first AV object, use the sample to identify a matching first audio in a computer associated with the artist, and store a copy of the first audio with the APS.

In another aspect, a device includes at least one computer readable storage medium bearing instructions executable by a processor, and at least one processor configured for accessing the computer readable storage medium to execute the instructions to configure the processor to establish an audio purchase account with an audio purchasing service (APS) for at least a first artist having at least an artist computer and a system identification with at least one audio video (AV) Internet site on which the first artist has provided one or more AV objects having respective audio portions. The instructions when executed by the processor configure the processor to, using the system identification in the audio purchase account, fetch from the AV Internet site indicators of the AV objects associated with the first artist to generate a list of the AV objects and provide a user interface (UI) to the artist computer including the list of the AV objects and one or more selectors enabling the artist to select at least a first AV object. The instructions when executed by the processor configure the processor to present a first selector to the artist computer, and responsive to selection of the first selector, access the AV Internet site, extract audio from the first AV object, and store the audio in a data storage associated with the APS.

In some implementations of this latter aspect, the instructions when executed by the processor configure the processor to present to the artist computer a second selector, and responsive to selection of the second selector, append to one or more pages on the AV Internet site of selected AV objects from the UI respective audio-only purchase links. Each audio-only purchase link is selectable by a consumer accessing the AV Internet site to link the consumer to the APS to facilitate a transaction for the audio but not the video associated with the audio-only purchase link selected by the consumer.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIGS. 2-4 are flow charts of example logic according to present principles;

FIG. 5 is a screen shot of an example non-limiting user interface (UI) presented on an artist computer to allow the artist to arrange to sell his music in music videos;

FIG. 6 is a flow chart of example audio-only purchase logic;

FIG. 7 is a screen shot of a UI that can be presented by an Internet AV site to enable a user to purchase only the audio associated with an AV program;

FIGS. 8 and 9 are flow charts of example alternate setup logic; and

FIGS. 10 and 11 are screen shots of example UIs related to the logic of FIG. 9.

### DETAILED DESCRIPTION OF THE PREFERRED EMBODIMENT

This disclosure relates generally to computer systems including aspects of consumer electronics (CE) device based user information and media buys in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

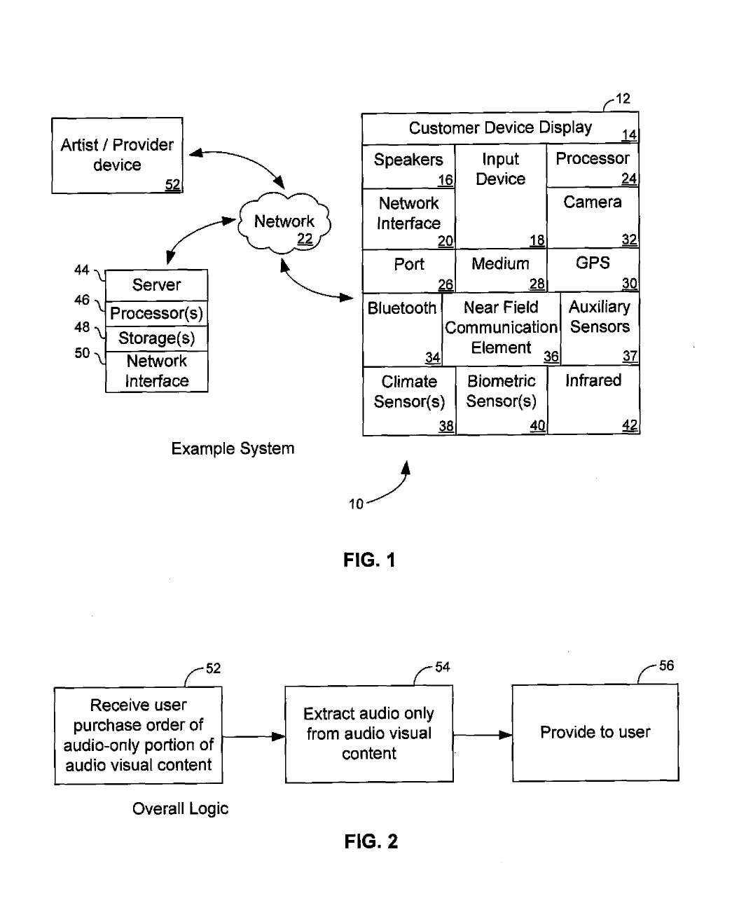

Now specifically referring to FIG. 1, an example system 10 is shown, which may include one or more of the example devices mentioned above and described further below in accordance with present principles. The first of the example devices included in the system 10 is an example consumer electronics (CE) device, and in the embodiment shown is an audio-only or audio and video display device (collectively, AVDD) 12 such as but not limited to a wireless “smart” phone, a tablet computer, a notebook or laptop computer, an Internet-enabled TV, or other appropriate CE device. Indeed, the AVDD 12 alternatively may be an appliance or household item, e.g. computerized Internet enabled refrigerator, washer, or dryer. The AVDD 12 alternatively may be a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a standard definition display, a high definition or ultra-high definition flat screen, a liquid crystal display (LCD), a light emitting diode (LED)-based display, or other suitable display and the display may be touch-enabled for receiving user input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for wired and/or wireless communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a user through the headphones. The AVDD 12 may further include one or more tangible computer readable storage medium 28 such as disk-based or solid state storage. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

The AVDD 12 may communicate over one or more of the network interfaces described above with one or more network servers 44 that includes at least one server processor 46, at least one tangible computer readable storage medium 48 such as disk-based or solid state storage, and at least one network interface 50 that, under control of the server processor 46, allows for communication with the other devices of FIG. 1 over the network 22, and indeed may facilitate communication between servers and client devices in accordance with present principles. Note that the network interface 50 may be, e.g., a wired or wireless modem or router, Wi-Fi transceiver, or other appropriate interface such as, e.g., a wireless telephony transceiver.

Accordingly, in some embodiments the server 44 may be an Internet server, and may include and perform “cloud” functions such that the devices of the system 10 may access a “cloud” environment via the server 44 in example embodiments.

Other servers and other devices may access the network 22. For example, an artist or content provider device 52 may access the network 22 for purposes to be shortly disclosed. The artist device 52 may include some or all of the same components as the AVDD 12 shown in FIG. 1 and described above.

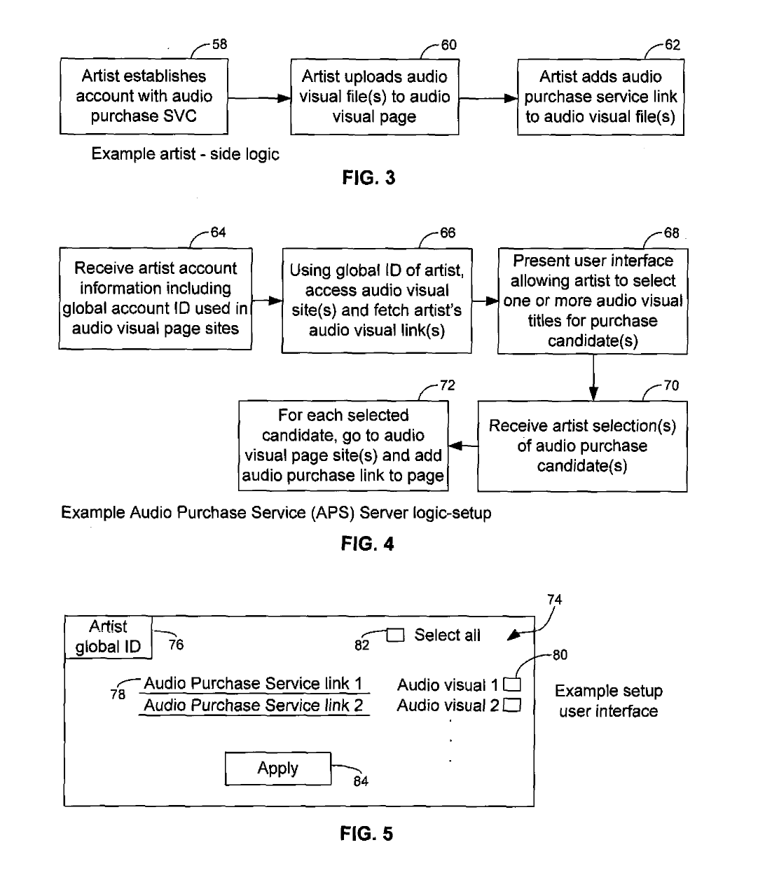

Overall purchase logic is shown in FIG. 2. Commencing at block 52, a user purchase order of an audio-only portion of audio video (AV) such as an AV entity such as an AV object is received, e.g., by a server such as the server 44 implementing an audio purchasing service (APS). The user request may in part be generated by a user clicking on the above-mentioned CPL in the description area of a web page of an AV object. At block 54 the audio only is extracted from the AV object and provided to the user at block 56.

As discussed further below, when clicking on a CPL on an AV web page, the user may be redirected by means of a network address link underlying the CPL to an audio purchase shopping cart web page hosted by the APS server. As part of the redirection, the AV page address, consumer computer address, and the identification of the selected AV file may be provided to the APS server via the shopping cart web page. Using the shopping cart web page, a consumer can pay for the audio portion of the AV file. Responsive to successful payment, the APS server may accesses the AV web page to in turn access the selected AV object, fetch the AV object, and extract the audio portion of the selected AV file using a system tool such as “FFmpeg”. Using the consumer computer address received as divulged above, the service downloads the audio-only file to the consumer computer at block 56. Preferably, the audio file is sent to the data partition identified by the consumer computer as the consumer's media library.

FIG. 3 shows example artist computer logic for enabling an artist to arrange to have his audio tracks purchased from AV web sites. At block 58, the artist computer establishes an account with the APS server. Typically before establishing the account in some example non-limiting embodiments the artist may first have uploaded one or more AV objects to one or more AV web sites such as but not limited to YouTube. At block 62 the artists adds an audio purchase link such as the CPL to one or more of his AV objects on the AV web site(s). Details of example ways to do this are given below.

More specifically and now referring to FIG. 4, in one example implementation at block 64 the APS server receives from an artist's computer account information including a global account identification of the artist used in AV page Internet site(s). As a non-limiting example, artists typically use gmail IDs when uploading AV files to YouTube, and this same ID is provided by user input at the artist computer to the artist's account with the APS server.

Using that ID, the APS server can then access the artist's various AV files on AV web sites such as YouTube at block 66. The links to the AV files are thereby obtained using one or more application programming interfaces (APIs) commonly provided by the AV web site, and a UI presented at block 68 by the APS server to the artist computer allowing the artist to select one or more AV titles as audio-only purchase candidates. The artist selection(s) of candidates are received at block 70 by the APS server and at block 72 the APS server navigates to the AV web site(s) to add an audio purchase link such as the CPL to the description areas of the selected candidate AV files, again typically using APIs provided by the AV web site.

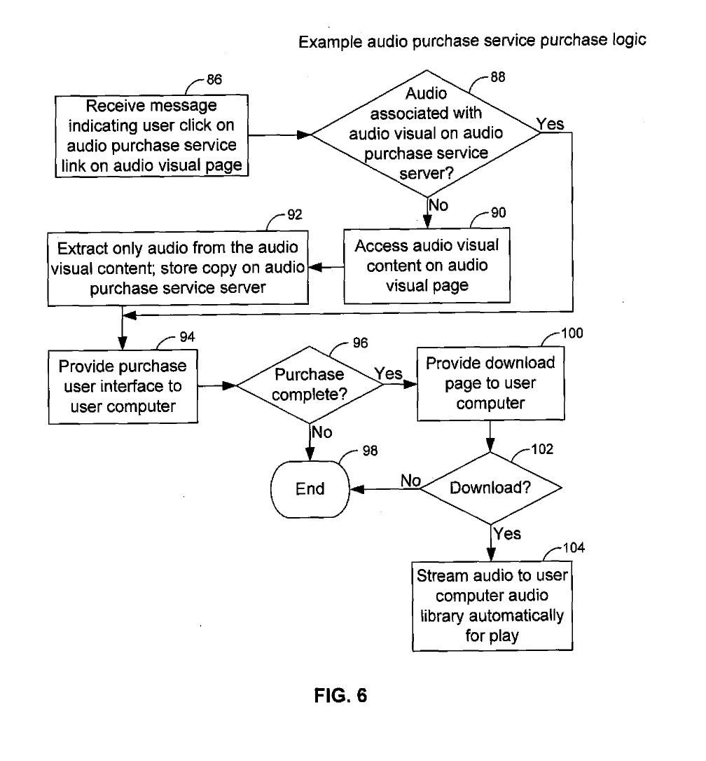

FIG. 5 shows such as UI 74 that may be presented on a display of an artist computer. The artist enters his global ID in the field 76 and after accessing the AV site(s) with that ID to obtain the links to the artist's AV files (as mentioned above in describing block 66 of FIG. 4), the various AV files are listed at 78. The list may be by file name or title and by a newly-populated network link or address for each file that is unique for the respective file and that will be associated with the CPL once the CPL is appended to the AV file on the AV web site. These newly-populated network links or addresses include network paths that point to the APS server and that indicate the identity such as the file name of the respective AV object (such as a file).

As mentioned above with respect to block 70 in FIG. 4, the artist may select individual selectors 80 for each AV file in the list to designate it as a candidate for audio-only purchase. Or, the artist may select an “all” selector 82 to select all of the AV files on the list as candidates. As alluded to above with respect to block 72 in FIG. 4, the artist may then select an “apply” selector 84, which causes the APS server to access the AV web site(s) and append or otherwise add an audio purchase link such as the CPL to the description areas of the artist-selected candidate AV files.

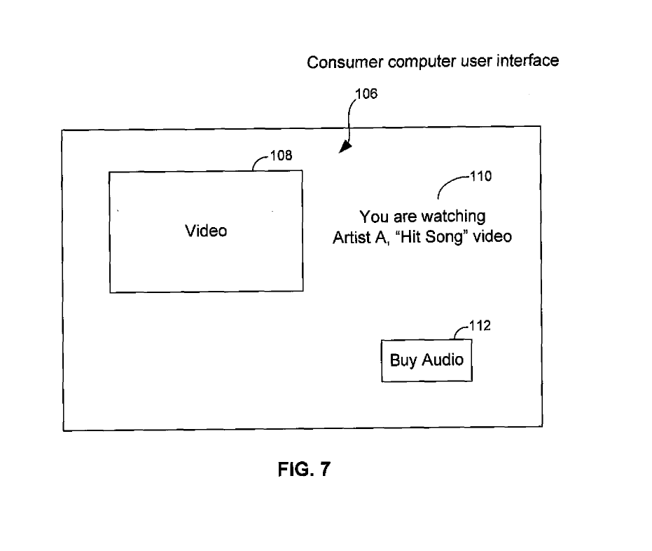

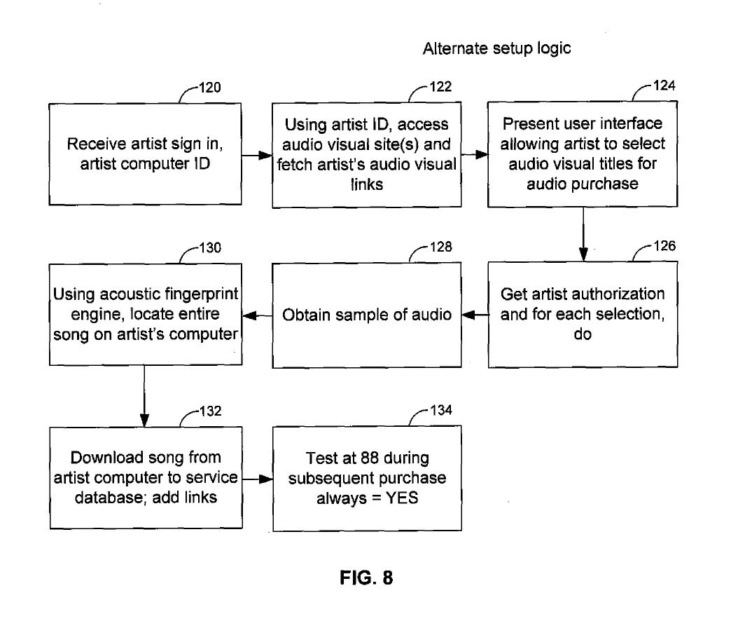

Having described how an artist can arrange to sell audio-only files from the AV files he or she has uploaded to AV web sites such as YouTube, attention is now drawn to FIGS. 6 and 7 to explain details of an example purchase process using the audio purchase links on the AV file page(s). At block 86, the APS server receives a message or other indication that a user has selected the below-described “buy audio” selector (referred to above as the audio purchase link such as a CPL) on the web page of one of the artist's AV files. It will readily be appreciated that since the audio purchase link is associated with the APS server, the user computer, in clicking the audio purchase link, is redirected to the APS server, and establishes communication with the APS server. It will also be appreciated that since the audio purchase link was generated with an indication of the associated AV object to which it was appended, the APS server knows what AV file (equivalently, what AV web page hosting the file) the user evinced a desire to purchase the audio from.

At decision diamond 88, the APS server determines whether the audio from the AV file identified in the redirect link is stored on an APS server data storage. To do this, it looks up by AV file name the AV files in its data storage, and if the AV file name is not found, the APS server logic moves to block 90 to access the AV file on the AV web site from which the user computer was redirected. At block 92, the audio portion of the AV object is extracted and a copy is stored on the data storage of the APS server. The video portion is not stored by the APS server.

In extracting the audio only, the APS server uses a tool such as a Linux tool such as “FFMpeg” mentioned above to extract audio-formatted data from an AV object. In an example, audio-formatted data can be identified by a file extension such as but not limited “.aac” indicating that file is an audio-formatted file. After extraction, the audio portion may be transcoded to, for example, mp3 format.

In any case, as consumers purchase the audio-only portions of AV files, each audio-only portion is stored by the APS service on its server. Furthermore, as part of storing the audio-only files, the APS service labels each audio file with a unique identifier, which is some embodiments may include the address of the AV page hosting the combined AV file, a unique subscript, and the identification of the combined AV file itself. Therefore, for subsequent audio file-only purchases, the service can first search its own server storage by the identification of the combined AV file associated with the desired audio file and if found on its own server, download the audio file to the subsequent purchasing consumer. The service thus need access combined AV files and extract audio therefrom only for the initial purchase of any particular audio file, e.g., only for the initial purchase of a song, otherwise directly accessing the audio file (e.g., song) on its own storage.

From block 92, or from decision diamond 88 when it is determined that the requested audio already resides on the data storage of the APS server, the logic moves to block 94 to provide to the user computer a purchase UI. The purchase UI typically includes fields into which the user can enter credit card or other accounting information, along with a delivery address, either physical or more typically a user device network address. If the purchase is not successfully completed at decision diamond 96 the logic may end at state 98, but otherwise the logic moves to block 100 to provide a download page to the user computer that the user can employ to select to download the purchased audio at decision diamond 102. Selection to download results in the audio being streamed to the designated user computer address at block 104, with the audio being automatically sent to the user computer audio library (typically under the direction of the operating system of the user computer) and if desired automatically played on the user computer as well. The entity affiliated with the APS server may be remunerated a percentage of the sales price of each purchased audio.

FIG. 7 shows an example UI 106 that may be presented on a user computer by an AV web site such as YouTube. Video may be presented in a video window 108 while accompanying audio is played on the speakers of the user computer. An informational message 110 may indicate the artist name and AV file title. A “buy audio” selector 112, referred to above as an audio purchase selector or CPL, may be selected by the user to initiate the logic of FIG. 6 starting at block 86.

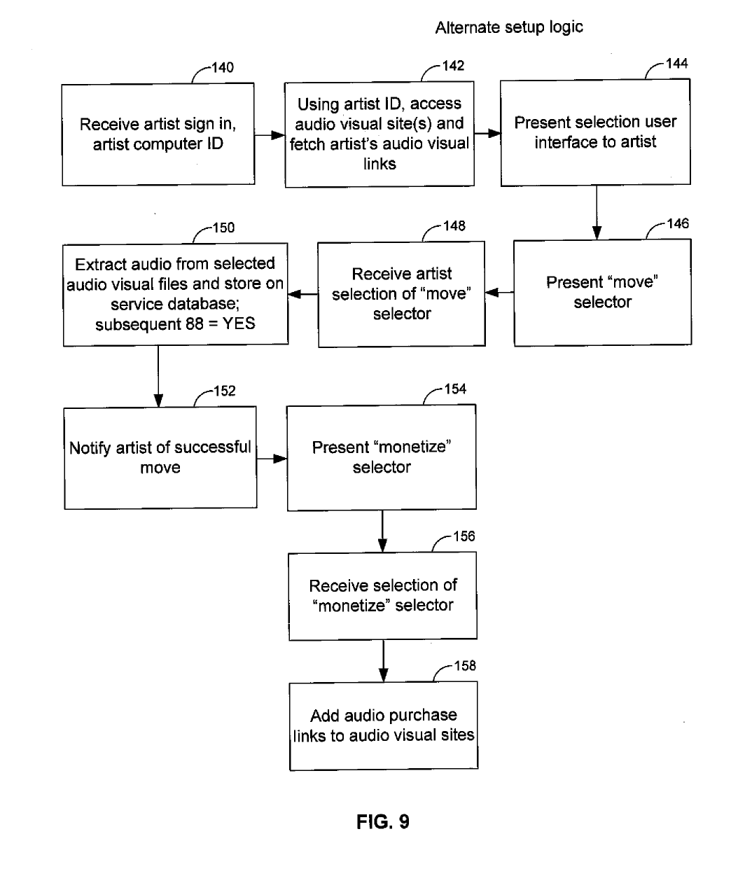

FIGS. 8 and 9-11 show alternate logic to set up the artist's account on the audio purchase website. Note that in the logic of these figures, the artist owning AV files gives approval to the APS to share the AV files of the artist, and then the APS extracts the audio associated with the AV files of the artist. Thus, as described further below, when an artist is shown the selection screen mentioned previously showing links to the artist's AV files on an AV site and selects the audio from those AV files he wants to sell, the artists gives an authorization to share his AV files with the APS, which then stores only the audio files in its database. The APS also pushes the audio purchase links to the AV sites where fans of the artists can select to purchase the audio. Thus, in the embodiments below it is not the purchaser (fan) causing the download and storage of the song on the APS, but rather, it is the artist causing the sharing and downloading of the song with the APS. When the song resides in the APS database, then it is available for purchase by the fan's action.

In FIG. 8, blocks 120-124 are analogous to blocks 64-68 in FIG. 4, with some differences noted below. Thus, at block 120, the APS server receives from an artist's computer account information including a global account identification of the artist used in AV page Internet site(s), as well as the network address of the artist's personal computer on which the artist's songs reside by, e.g., artist input or, if the artist is using the same computer to contact the APS, by the network address that accompanies the artist's contact.

Using the ID, the APS server can then access the artist's various AV files on AV web sites such as YouTube at block 122. The links to the AV files are thereby obtained using one or more application programming interfaces (APIs) commonly provided by the AV web site, and a UI presented at block 124 by the APS server to the artist computer allowing the artist to select one or more AV titles as audio-only purchase candidates. The artist selection(s) of candidates are received by the APS server.

Once the APS server has received the artist selections, the APS server may present a query UI at block 126 to the artist computer seeking permission to obtain the audio files associated with the selected AV files from the artist's computer. This may be done once for a global authorization or on a track by track basis. For each selection by the artist that the artist has also authorized access on his personal computer to obtain, the logic executes blocks 128-132 to access the artist computer on which the audio resides using the artist computer ID/network address received at block 120.

With more specificity, at block 128 a sample of the audio is obtained from the associated AV object on the AV website from which the links were obtained at block 122. This may be done by selecting the associated AV object for play and recording a portion of the audio. The portion may be, e.g., a ten second clip of the audio or other fraction of the entire audio file.

Moving to block 130, the sample portion is used as entering argument in accessing the audio files on the artist computer, which can be played by the APS server and compared against the sample portion to identify which audio file on the artist computer matches the portion. An audio fingerprint engine such as “Shazam” may be used for this comparison. When a match is found, at block 132 the entire matching song on the artist computer is copied by the APS server and stored in the APS server database, and the APS server navigates to the AV web site(s) to add an audio purchase link such as the CPL to the description areas of the selected candidate AV files. Block 134 simply indicates that since the audio files are pre-loaded onto the APS server database, tests at decision diamond 88 in FIG. 6 during subsequent buyer purchases from the AV site(s) typically will return “yes”. Alternatively, the test at decision diamond 88 in FIG. 6 may be omitted along with states 90 and 92, and the logic of FIG. 6 may instead proceed directly from block 86 to block 94, the audio files having already been obtained by the APS server in FIG. 8.

FIG. 9 shows alternate logic to set up the artist's account on the audio purchase website. Blocks 140-144 are analogous to blocks 64-68 in FIG. 4, with some differences noted below. Thus, at block 140, the APS server receives from an artist's computer account information including a global account identification of the artist used in AV page Internet site(s).

Using the ID, the APS server can then access the artist's various AV files on AV web sites such as YouTube at block 142. The links to the AV files are thereby obtained using one or more application programming interfaces (APIs) commonly provided by the AV web site, and a UI presented at block 144 by the APS server to the artist computer allowing the artist to select one or more AV titles as audio-only purchase candidates. The artist selection(s) of candidates are received by the APS server.

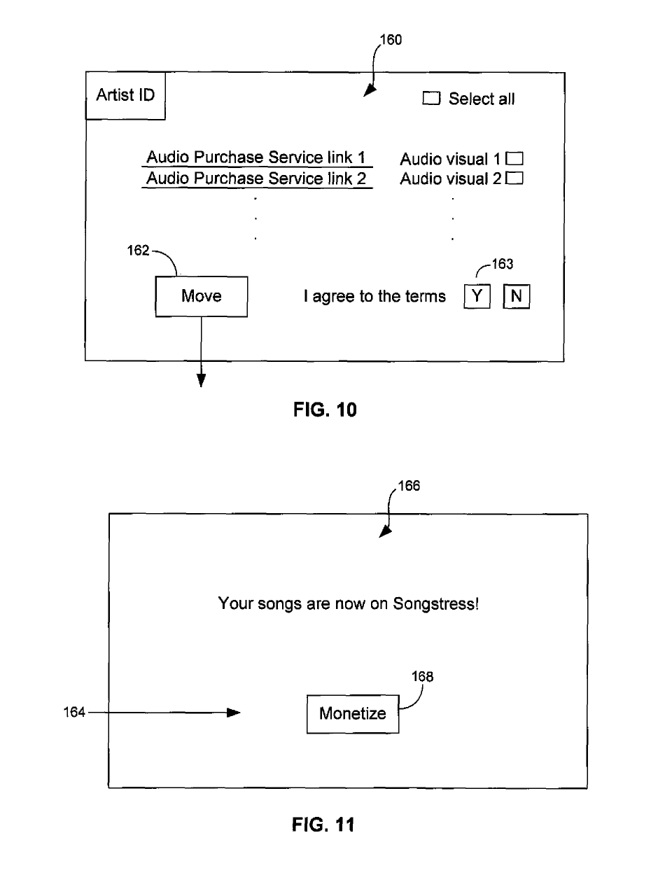

In the embodiment shown in FIG. 9, the APS server may present to the artist computer a selector to indicate whether the artist accepts (or not) terms and conditions that may be delineated by the APS on the UI. If the artist accepts, a “move” selector, an example of which is discussed further below in reference to FIG. 10, may be presented at block 146 for the artist to select to cause the APS to, in response at block 148, receive the selection and in response to that move to block 150 to access the selected AV files from the AV website(s). At block 150, the audio is extracted from the AV objects as described previously and stored on the APS database, incidentally meaning that tests during subsequent purchases at decision diamond 88 of FIG. 6 typically will result in “yes”. Alternatively, the test at decision diamond 88 in FIG. 6 may be omitted along with states 90 and 92, and the logic of FIG. 6 may instead proceed directly from block 86 to block 94, the audio files having already been obtained by the APS server in FIG. 9.

If desired, the APS may present a UI at block 152 such as the UI shown in FIG. 11 informing the artist that the artist has successfully caused his audio content to by stored on a database of the APS service. An “OK” selector may be provided in some examples. Responsive to the artist acknowledging the message, or immediately with the message if no “OK” selector is presented, a “monetize” or “sell” selector may be presented at block 154 which if selected by the artist and received at block 156 causes the APS to add the audio purchase links to the AV site(s) as described previously, so that fans of the artist can purchase the audio.

FIG. 10 shows an artist selection UI similar to the UI shown in FIG. 5 but with the above-described “move” selector 162 which must be selected to precipitate copying the audio files from the AV site(s). Note that the move selector 162 may not be enabled until the artist selects a “yes” selector 163 indicating acceptance of terms and conditions.

FIG. 11 shows a UI 164 that may be presented once the audio files have been successfully moved from the AV site(s) to the APS with a “successful move” message 166. To cause the APS to populate the AV site(s) with the audio purchase links as described above, a monetize selector 168 may be presented which can be selected by the artist to precipitate the logic at block 158 of FIG. 9.

While the particular AUDIO-ONLY FILE PROVISIONING FROM INTERNET VIDEO is herein shown and described in detail, it is to be understood that the subject matter which is encompassed by the present invention is limited only by the claims.

1. A device comprising:
at least one computer memory that is not a transitory signal and that comprises instructions executable by a processor
responsive to a selection from a user computer of a link on an audio video (AV) web page to purchase only an audio portion of an AV object, provide a purchase web page to the user computer;
determine whether the audio portion is stored in a device storage at least in part using an identification of the audio portion;
responsive to a determination that the audio portion is stored in the device storage and at least one download signal, download a copy of the audio portion from the device storage to the user computer; and
responsive to a determination that the audio portion is not stored in the device storage, access the AV object, extract a copy of the audio portion therefrom to establish an extracted copy, and provide, in response to at least one download signal, the extracted copy to the user computer, and further store the extracted copy on the device storage.

2. The device of claim 1, wherein the identification of the audio portion is established at least in part by the address of the AV web page and an identification of the AV object.

3. The device of claim 2, wherein the identification of the audio portion is established at least in part by a subscript.

4. The device of claim 1, wherein the instructions are executable to:
responsive to a determination that the audio portion is not stored in the device storage and establishing the extracted copy, add the identification of the audio portion in the extracted copy.

5. The device of claim 1, wherein the AV object includes a video-only file and an audio-only file.

6. The device of claim 5, wherein the AV object is a music video and the audio-only file. is a music file.

7. A method comprising:
responsive to a purchase signal from a user computer, accessing a data storage storing an audio video (AV) entity containing digitized video and audio that is associated with the video;
extracting only the audio from the AV entity; and
providing, pursuant to the purchase signal, only the audio to the user computer and not provide video from the AV entity to the user computer pursuant to the purchase signal.

8. The method of claim 7, wherein the AV entity is an AV object including a video-only file and an audio-only file.

9. The method of claim 8, the AV object is a music video and the audio file is a music file.

10. The method of claim 7, comprising:
responsive to a selection from a user computer of a link on an AV web page to purchase only the audio of the AV entity, providing a purchase web page to the user computer;
determining whether the audio is stored in a device storage at least in part using an identification of the audio;
responsive to a determination that the audio is stored in the device storage, downloading a copy of the audio from the device storage to the user computer responsive to at least one download signal; and
responsive to a determination that the audio is not stored in the device storage, accessing the AV entity, extracting a copy of the audio portion therefrom to establish an extracted copy, and providing, responsive to at least one download signal, the extracted copy to the user computer, and further storing the extracted copy on the device storage.

11. The method of claim 10, wherein the identification of the audio is established at least in part by the address of the AV web page and an identification of the AV entity.

12. The method of claim 11, wherein the identification of the audio is established at least in part by a subscript.

13. The method of claim 10, comprising:
responsive to a determination that the audio is not stored in the device storage and establishing the extracted copy, adding the identification of the audio to the extracted copy.

14. A device comprising:
at least one computer memory that is not a transitory signal and that comprises instructions executable by a processor;
at least one processor configured for accessing the computer readable storage medium to execute the instructions to configure the processor to:
establish an audio purchase account with an audio purchasing service (APS) for at least a first artist having at least an artist computer and a system identification with at least one audio video (AV) Internet site on which the first artist has provided one or more AV objects having respective audio portions;
using the system identification in the audio purchase account, fetch from the AV Internet site indicators of the AV objects associated with the first artist to generate a list of the AV objects;
provide a user interface (UI) to the artist computer including the list of the AV objects and one or more selectors enabling the artist to select to append, on the AV Internet site, audio-only purchase links to one or more of the AV objects; and
responsive to selection of one or more selectors, append to one or more pages on the AV Internet site of selected AV objects from the UI respective audio-only purchase links, each audio-only purchase link being selectable by a consumer accessing the AV Internet site to link the consumer to the APS to facilitate a transaction for the audio but not the video associated with the audio-only purchase link selected by the consumer.

15. The device of claim 14, wherein the instructions are executable to:
responsive to a selection from a user computer of an audio-only link associated with a first AV object on the AV Internet site, provide a purchase web page to the user computer to enable purchase of the audio associated with the audio-only link;
determine whether the audio is stored in a device storage at least in part using an identification of the audio;
responsive to a determination that the audio is stored in the device storage, download a copy of the audio from the device storage to the user computer responsive to at least one download signal; and
responsive to a determination that the audio is not stored in the device storage, access the first AV object, extract a copy of the audio therefrom to establish an extracted copy, and provide, responsive to at least one download signal, the extracted copy to the user computer, and further store the extracted copy on the device storage.

16. The device of claim 15, wherein the identification of the audio portion is established at least in part by the address of the AV web page and an identification of the AV object.

17. The device of claim 16, wherein the identification of the audio portion is established at least in part by a subscript.

18. The device of claim 15, wherein the instructions are executable to:
responsive to a determination that the audio is not stored in the device storage and establishing the extracted copy, add the identification of the audio to the extracted copy.

19. The device of claim 15, wherein the first AV object includes a video-only file and an audio-only file.

20. The device of claim 19, wherein the AV object is a music video and the audio-only file is a music file.

21. A device comprising:
at least one computer memory that is not a transitory signal and that comprises instructions executable by a processor;
at least one processor configured for accessing the computer readable storage medium to execute the instructions to configure the processor to:
establish an audio purchase account with an audio purchasing service (APS) for at least a first artist having at least an artist computer and a system identification with at least one audio video (AV) Internet site on which the first artist has provided one or more AV objects having respective audio portions;
using the system identification in the audio purchase account, fetch from the AV Internet site indicators of the AV objects associated with the first artist to generate a list of the AV objects;
provide a user interface (UI) to the artist computer including the list of the AV objects and one or more selectors enabling the artist to select at least a first AV object;
responsive to artist selection of the first AV object, obtain from the AV Internet site at least a sample of audio associated with the first AV object;
use the sample to identify a matching first audio in a computer associated with the artist; and
store a copy of the first audio with the APS.

22. The device of claim 21, wherein the instructions are executable to append to one or more pages on the AV Internet site of selected AV objects from the UI respective audio-only purchase links, each audio-only purchase link being selectable by a consumer accessing the AV Internet site to link the consumer to the APS to facilitate a transaction for the audio but not the video associated with the audio-only purchase link selected by the consumer.

23. The device of claim 22, wherein the instructions are executable to:
responsive to a selection from a user computer of an audio-only link associated with a first AV object on the AV Internet site, provide a purchase web page to the user computer to enable purchase of the audio associated with the audio-only link;
download a copy of the audio from the device storage to the user computer responsive to at least one download signal.

24. The device of claim 21, wherein the first audio is associated with an identification established at least in part by the address of the AV web page and an identification of the AV object.

25. The device of claim 24, wherein the identification of the audio portion is established at least in part by a subscript.

26. A device comprising:
at least one computer memory that is not a transitory signal and that comprises instructions executable by a processor;
at least one processor configured for accessing the computer readable storage medium to execute the instructions configure the processor to:
establish an audio purchase account with an audio purchasing service (APS) for at least a first artist having at least an artist computer and a system identification with at least one audio video (AV) Internet site on which the first artist has provided one or more AV objects having respective audio portions;
using the system identification to the audio purchase account, fetch from the AV Internet site indicators of the AV objects associated with the first artist to generate a list of the AV objects;
provide a user interface (UI) to the artist computer including the list of the AV objects and one or more selectors enabling the artist to select at least a first AV object;
present a first selector to the artist computer; and
responsive to selection of the first selector, access the AV Internet site, extract audio from the first AV object and store the audio in a data storage associated with the APS.

27. The device of claim 26, wherein the instructions are executable to:
present to the artist computer a second selector; and
responsive to selection of the second selector, append to one or more pages on the AV Internet site of selected AV objects from the UI respective audio-only purchase links, each audio-only purchase link being selectable by a consumer accessing the AV Internet site to link the consumer to the APS to facilitate a transaction for the audio but not the video associated with the audio-only purchase link selected by the consumer.

28. The device of claim 27, wherein the instructions are executable to:
responsive to a selection from a user computer of an audio-only link associated with a first AV object on the AV Internet site, provide a purchase web page to the user computer to enable purchase of the audio associated with the audio-only link; and
download a copy of the audio from the device storage to the user computer responsive to at least one download signal.

29. The device of claim 26, wherein the first audio is associated with an identification established at least in part by the address of the AV web page and an identification of the AV object.

30. The device of claim 29, wherein the identification of the audio portion is established at least in part by is subscript.
